(19) United States
(12) Patent Application Publication
(10) Pub. No.: US 2007/0132555 A1
(43) Pub. Date: Jun. 14, 2007

(54) Ultra low frequency tag and system

(76) Inventors: Jason August, Toronto (CA); Paul Waterhouse, Selkirk (CA); John K. Stevens, Stratham, NH (US); Michael J. Vandenberg, Ontario (CA); Kenneth Truong, Scarborough (CA)

Correspondence Address: MICHAEL J. BUCHENHORNER, 8540 S.W. 83 STREET, MIAMI, FL, 33143, US

(21) Appl. No.: 11/353,766

(22) Filed: Feb. 14, 2006

Related U.S. Application Data
(60) Provisional application No. 60/652,554, filed on Feb. 14, 2005.

(51) Int. Cl. G08B 13/14; H04Q 5/22

(52) U.S. Cl. 340/10.1; 340/572.2; 340/10.2; 340/539.22; 340/10.3

(57) ABSTRACT

Active high frequency radio tags have two major disadvantages: First, since the power consumption of any solid state circuit is proportional to the operating speed, active LF,HF and UHF tags require large batteries with limited life (two to maximum five years) and as a result are bulky heavy devices; Second, they must use high speed semiconductor devices that have a major impact on the active tag costs as compared to other semiconductor processes that operate at lower frequencies. The present invention provides a method, system, and ultra low frequency (below 1 megahertz) tag for detection and tracking of animate and inanimate objects attached thereto, the aforesaid ULF tag comprising: a) a tag antenna (e.g. wound on a ferrite core) operable at a low radio frequency below 1 megahertz; b) a communication device operatively connected to the aforesaid tag antenna and operable to transmit data at the aforesaid low radio frequency; c) a clock device, such as a crystal with a natural frequency (with characteristic variations in phase or amplitude to enable discovery of tags within the field of a large loop antenna) operatively connected to the aforesaid communication device and operable to emit clock data to determine the aforesaid low radio frequency; and d) an energy storage device operable to activate the aforesaid communication device and the aforesaid clock device.

This application claims priority from U.S. Provisional Application No. US/60/652,554 Ultra Low Frequency Tag and System, filed Feb. 14, 2005; and U.S. Ser. No. 11/161,032 filed on Jul. 20, 2005 entitled “RF Enablement of Products and Receptacles Therefor”, which are all incorporated herein by reference.

### FIELD OF THE INVENTION

The present invention relates to methods and systems for detection and tracking of animate and inanimate objects, and to ultra low frequency (ULF) radio frequency tags that are carried by such objects.

### BACKGROUND OF THE INVENTION

Radio Frequency Identity tags or RFID tags have a long history and have been based largely upon the use of “transponders” tags with a fixed pre-programmed ID. These tags are often designed to replace barcodes and are capable of low power two way communications (U.S. Pat. No. 3,713,148, The Mercury News, RFID pioneers discuss its origins. Sun, Jul. 18, 2004). Active RFID tags have a battery to power the tag circuitry. They are typically large devices operating in the 13 Mhz to 2.3 Ghz frequency range. and work as transponders. A transponder uses a carrier transmitted by a base station to and the tag usually communicates by simply shorting or de-tuning a resonate tuned antenna to produce a change in the reflected energy. This produces a reflected signal that can be detected by a base station and minimizes the complexity of the circuity contained in the tag. Passive RFID transponder tags do not have a battery and use the same carrier signal for power.

Passive RF-ID tags also have an antenna consisting of a wire coil or an antenna coil etched onto a PC board. In passive tags, such an antenna coil serves four functions;
1. It serves as an antenna for detecting the carrier radio signals that contains the data signal;
2. It serves as a power source. The tag receives a carrier signal from a base station and uses the carrier signal to provide power to the integrated circuitry and logic on the tag; and
3. It may also serve as a frequency and phase reference for radio communications. The tag can use the same coil to receive a carrier at a precise frequency and phase reference for the circuitry within the radio tag for communications back to the reader/writer.
4. It can also serve as a clock used to drive the logic and circuitry within the integrated circuit. In some cases the carrier signal is modulated to produce a lower clock speed.

It is generally assumed that a Passive transponder tag is less costly than an active transponder tag since it has fewer components and is less complex. Thus, a passive transponder tag has the potential to eliminate the need and cost for a battery as well as an internal frequency reference standard such as a crystal or compensated oscillator (e.g U.S. Pat. No. 5,241,286) for precise control of phase and frequency. An active transponder tag only eliminates the crystal and requires the extra cost of battery. In addition, since passive transponder tags have precise known phase and frequency since they can use an external common reference (the carrier signal) it is possible to enhance extraction of the tag signal from background noise (U.S. Pat. No. 4,821,291). It is also possible to use this precise reference to provide enhanced anti-collision methods so as to make it possible to read many tags within a carrier field (U.S. Pat. No. 6,297,734, U.S. Pat. No. 6,566,997, U.S. Pat. No. 5,995,019. U.S. Pat. No. 5,591,951). Transponder RFID tags typically operate at several different frequencies within the Part15 rules of the FCC (Federal Communication Commission) between 10 Khz to 500 Khz (Low frequency or Ultra Low Frequency ULF), 13.56 Mhz (High Frequency, HF) in or 433 MHz and 868/915 MHz or 2.2 Ghz (Ultra High Frequency UHF). The higher frequencies are typically used to provide high bandwidth for communications, on a high speed conveyor for example, or where many thousands of tags must be read rapidly. In addition, the higher frequencies are more efficient for transmission of signals and require much smaller antennas for optimal transmission. (It may be noted that a self-resonated antenna for 915 Mhz can have a diameter as small as 0.5 cm).

Advantages of High Frequency Passive RFID Tags

These higher frequency (HF) and ultra high frequency (UHF) radio frequency (RF) tags are often used since they have the advantages of longer transmission distance (potentially over 100 feet) within the Part 15 FCC rules. As the transmission frequency goes down below 500 Khz, it is no longer possible to use optimal Electric Field antennas on the tag or from the base station, since the wave length is so very long (which requires a large antenna for signal detection). Because of the need for a smaller antenna foot print, HF and UHF are preferred frequencies for most RFID tags. In addition, optimal antennas at HF and UHF frequencies require very few turns to achieve resonance and may be printed directly onto flexible PC (printed circuit) boards as part of the etched traces on the board itself. Thus, the higher frequencies are thought to be far more efficient for transmission of signals because they require much smaller antennas and therefore eliminate the cost and need for a separate coil or wound antenna. In theory, this reduces production cost, and in some cases size, and makes it possible to produce, passive transponders tags with highly automated equipment at costs below 30 or 40 cents, at current (2005) price levels.

Finally, the higher HF/UHF frequencies also typically provide high speed and high bandwidth for communications. On a high speed conveyor for example, many 1,000's of tags attached to individual packages on a pallet moving at 6 mph. This means 200-300 tags must identified and read in under a few seconds. This result can only be achieved with a high bandwidth system with data rates near 1 Mhz and a carrier frequency in the 100's of Mhz.

One minor disadvantage of a system using HF and UHF passive tags is that the reader or base station must be more complex (over an active tag system) and is often more expensive. The reader must transmit a reference signal to power the passive RF tag as well as to provide a frequency standard. Often the algorithms used to network such HF/UHF tags may require complex circuitry in the base station as well. Finally, as the frequency goes up the cost of the integrated circuits require to read and write to the passive RF tags in the base station also rises. However, the working assumption is that the reader cost is not a major factor since it can be used over many millions of RF tags and that the tag cost is far more critical. Any functionality that can be moved to the reader from the RF tag therefore makes economic sense.

These passive HF/UHF tags may therefore be functionally quite simple and contain only an integrated circuit (IC), mounted on an etched flexible circuit board with no other components. No battery, no crystal and no other components are required, and the speed of data transmission can be high, so that the HF/UHF tags can be read at long range and at a low cost.

Disadvantages of Current Ultra Low Frequency (ULF)

Passive ultra low frequency (ULF) transponder radio tags are in widespread use as RFID tags for pets and livestock and even humans, largely because these frequencies are not affected by water or liquids contained in living animals. Higher frequencies are affected by the presence of water. However, because of many other disadvantages described below, ULF tags are generally not used for other applications.

The major disadvantage of ULF tags is that the detectable radiant energy leaving the transmission antenna is largely a magnetic (M) field rather than an electric (E) field. This magnetic mode of transmission (also called inductive transmission), has the major disadvantage of short range. The inductive signal drops off as 1/d³ while the electric field signals at higher frequency drops off 1/d², in the near field and 1/d in far field conditions, where “d” is distance from a point source antenna that radiates the signal. Thus, the inductive or M radiance mode of transmission will, theoretically and in practice, severely limit the distance of transmission to only a few inches. In addition ULF tags are very slow because the carrier frequency (e.g. 100 Kz to 200 Khz) is low compared to HF and UHF.

Since transmission is inductive the tag requires a separate, many-turn, wound wire antenna in place of the etched circuit board antenna. Thus, in general it is often assumed that ULF radio tags will be more expensive since they do require a wound wire antenna. However, it is possible to make a low cost ULF passive tag with an antenna coil and chip and no PC board (WO03094106A1) there are many other disadvantages with current commercial ULF tags.

Because of these many disadvantages of ULF, the RF-ID frequencies now recommended by many commercial (Item-Level Visibility In the Pharmaceutical Supply Chain: A Comparison of HF, UHF RFID Technologies, July 2004, Texas Instruments, Phillips Semiconductors, and TagSys Inc.), government organizations (see Radio Frequency Identification Feasibility Studies and Pilot, FDA Compliance Policy HFC-230, Sec 400.210, November, 2004, recommend use of LF, HF or UHF,) as well as standards associations (EPCglobal, web page tag specifications, January 2005, note ULF is excluded) do not mention or discuss the use of ULF as an option in many important applications. Many of the commercial organizations recommending the higher HF?UHF frequencies believe that passive and or active radio tags in these low frequencies are not suitable for any of these applications for reasons given above.

Many commercial companies actually manufacture both ULF and LF radio tags (e.g. both Texas Instruments and Philips Semiconductor. See Item-Level Visibility In the Pharmaceutical Supply Chain: A Comparison of HF, UHF RFID Technologies, July 2004, Texas Instruments, Phillips Semiconductors, and TagSys Inc.) yet recommend the use of 13.56 Mhz or higher again because of the many disadvantage of ULF outlined above, and the many advantages of HF and UHF).

A detailed summary of many of the reasons that current ULF radio tags have not generally been considered for use in many applications is summarized below.
1. ULF is believed to have very short range because it uses largely inductive or magnetic radiance that drops off 1/d³ while far field HF and UHF drops off 1/d, where d is distance from the source. Thus, the inductive or magnetic radiance mode of transmission will theoretically limit the distance of transmission, and that has been one of the major justifications for use of HF and UHF passive radio tags in many applications.
2. The transmission speed is inherently slow using ULF as compared to HF and UHF since the tag must communicate with low baud rates because of the low transmission carrier frequency.
3. Many sources of noise exist at these ULF frequencies from electronic devices, motors, florescent ballasts, computer systems, and power cables. Thus ULF is often thought to be inherently more susceptible to noise.
4. Radio tags in this ULF frequency range are thought to be more expensive since they require a wound coil antenna because of the requirement for many turns to achieve optimal electrical properties (maximum Q). In contrast HF and UHF tags can use antennas etched directly on a printed circuit board (while ULF would have even more serious distance limitations with such an etched antenna).
5. Current networking methods used by high frequency tags, as used in HF and UHF, are impractical due to such low bandwidth of ULF tags described above in point 2 immediately above.
   High Frequency and Ultra High Frequency Limitations in Certain Applications

Many, unexpected functional disadvantages have recently been discovered with actual widespread use of passive radio HF, and UHF tags in the field (“Radio tags are falling off the fast track”, The Boston Globe, Scott Kirsner, May 31, 2004; “Despite Wal-Mart's Edict, Radio Tags Will Take Time”, The New York Times, Barnaby Feder, Dec. 28, 2004).
1. Passive HF and UHF transponder tags transmit with limited power since they can obtain power only from a rectified carrier signal. In some tags this power requirement may limit the transmission range to only a few inches or at most to a few feet. This is especially true with 13.56 Mhz.
2. Passive HF and UHF transponder tags are highly angle sensitive. If tag is twisted by 20-30 degrees from parallel to the plane of the antenna the signal may drop enough to lead to a read failure. This is due to the limited dynamic range of the amplifier used in these tags since it is powered by the antenna coil. In other words it is possible to build an amplifier to read the reduced data signal over a wide dynamic range seen as the tag rotates, but nothing can be done when the power for the amplifier drops out because of the angle. When the power drops below a critical level as the tag rotates, then the chip and logic will simply stop functioning below this critical level.
3. HF and UHF transponder tags do not work well around metal or liquids. This is part due to limited transmission power, but also in part due to fact higher frequency radio signals reflect or are blocked by any conductive surface or material, and high frequencies are absorbed and as a result effectively blocked by liquids. In many cases the read errors rates are as high as 40% in a warehouse (“Radio tags are falling off the fast track”, The Boston Globe, Scott Kirsner, May 31, 2004).
4. Current anti-collision systems (see, for example, U.S. Pat. No. 6,297,734, U.S. Pat. No. 6,566,997, U.S. Pat. No. 5,995,019, U.S. Pat. No. 5,591,951), which are used to read or “discover” many tags within a field, limit the total number of HF/UHF tags that can be read at any time. In practice, only 25-50 tags can be read within a carrier field.
5. High frequency transponder tags often have a preprogrammed fixed ID, created at the time it is manufactured. This requires an external database and “lookup” function to discover the identity of the radio tag and to obtain information about the product or item that has been tagged. The direct cost associated with this external database is often difficult to predict in advance of any use and often requires additional expensive hardware such as a wireless handheld computer to identify an item in the field.
6. Many applications require that data be written and stored within a data storage device that is incorporated in the tag after the tag is attached to a tracked object and quickly read in the field without a database lookup. This requirement forces any passive transponder tag to use Electrical Erasable Programmed Read Only Memory (EEPROM) or similar storage system since it does not have a battery to maintain power for conventional Dynamic (DRAM) or Static (SRAM) memory. For example, the FDA recommends that all data be written to the tag after it is affixed to a container so that it can not be accidentally confused with another container (see Radio Frequency Identification Feasibility Studies and Pilot, FDA Compliance Policy HFC-230, Sec 400.210, November, 2004, 4. “Writing to a tag before it is affixed to a container increases the risk of product mix-ups. We suggest that industry and other interested parties explore the feasibility of writing to the tag after it is affixed to the container.”). This memory requirement in passive tags has several unexpected disadvantages:
   The cost of an EEPROM significantly raises the cost of the passive transponder tags since it involves many extra processing steps in the production of the integrated circuit. It may require as many as 22 steps compared to 14 for silicon gate CMOS. Since the cost of an integrated circuit is tied directly to number of processing steps this may have dramatic cost implications. In addition, the cost of EEPROM over conventional Random Access Memory (RAM) is significant since EEPROM also requires about 60% larger area on the integrated circuit over RAM. Again, costs of an integrated circuit is directly related to its area.
   EEPROM data storage on a tag significantly slows down the read and write process—in some cases more than 1000 times over what could be archived with conventional static memory. Communication speed with a passive HF/ULF tag that has a read/write memory requirement may be significantly reduced. As a result most applications using passive HF/ULF tags use a large fixed ID that must be programmed as described under point 5, above, and this leads to significant increased IT (information technology) costs.
   EEPROM storage requires significantly more power than conventional SRAM and this additional power requirement may also reduce read distance and increase angle sensitivity, especially if many reads and writes to memory are required.
   In practice, because of the increased size of the chip, speed, and related power requirements, passive RF chips are limited to about 2,048 bits or 256 bytes of memory. In many applications where data may have to be logged repeatedly over long period of time (temperature for example) this storage size is not sufficient.
7. In many cases, especially in healthcare applications, it may also be important to frequently monitor the temperature or humidity of the product, and this cannot be carried out without some source of power. Also, an RF tag cannot record temperature along with time—either as a histogram or data log, without an active clock and time of day that is independent of the carrier frequency.
8. In many cases, a light emitting diode (LED) warning device, as part of the high frequency passive tag, could be used to identify selected items to be removed from an area or to be placed on a shelf. However, this additional power requirement of an LED would lead to both significant reduction in range of signal transmission by the tag and an increased angle sensitivity of the tag.
9. The HF and UHF passive tags often must be read with a hand held computer brought within close reading distance to the tag. For example, a wrist band used for patients in a hospital may have many arbitrary positions and angles. It is difficult to place a reader on a wall and guarantee that it is possible to capture data as the wrist-tagged patient passes by. Therefore, a nurse or other professional may be needed to take a hand held computer to read the tag to identify the patient, as well as to document the patient's location at that time. This new additional manual step often leads to unreliability within any inventory management system or tracking system.
10. The handheld reader that is needed to read a HF/UHF tag may be quite expensive for several reasons. Firstly, the read/write circuitry of the reader must be complex in order to make the radio tag correspondingly low cost and simple. In addition, since many tags must use a fixed ID that is an arbitrary number the handheld reader must “lookup” the ID in a database stored on a remote computer. This may require that the handheld reader be equipped with a longer range RF link to a computer, thereby further adding to the cost.
11. The passive HF and UHF tags were thought to help prevent counterfeiting of products. However, since the tag has no memory or limited memory, and no clock to keep track of date and time, it is difficult to provide any public key or encryption protocols that could provide reasonable security systems as a proof of identity or proof of the tag's data content.
12. The passive HF and UHF tags require antennas that have reduced size flexibility. After the antenna reaches a certain frequency-dependent size limit, the gain of the antenna is reduced and it cannot be tuned.

Thus, many unexpected complex issues have appeared as passive HF/UHF RFID tags have been put into widespread use for detection and tracking of animate and inanimate objects attached to the tags. While many of the current passive transponder tags can be used in applications that do not require significant memory and do require high speed, many of the existing commercial passive transponder tags can not be used reliably in applications that might make use of steel or metal shelves, on liquid products, or in applications that must read near or in living animals or humans (eg. livestock identification) especially on injectable or liquid pharmaceuticals, or on medical devices such as DES stents, boxes of sutures, or orthopedic joints where sealed aluminum pouches are often used to hold the sterile joint device, wrist bands used to track patents in hospitals. Similar technical problems are encountered when blood plasma is tracked in one liter bags, with livestock, cattle, pigs and the like and other that must be tracked to establish a health pedigree prior to slaughter, with steel replacement parts and tools used for aircraft maintenance, with systems that track tools during maintenance, and with toxic wastes contained in steel 55 gallon drums, when tracking airline baggage that may contain steel or metal and liquids; all such readings have proven to be unreliable with passive radio transponder tags that operate at high and ultra-high frequencies (HF and UHF).

Finally, passive transponder tags have not been successful in providing real time inventory or automated visibility for products in harsh environments or near steel shelves because of the issues raised above and the limited ability to read many HF/UHF tags within a carrier field in such harsh environments. These problems occur for:
1. Steel or metal shelf, applications that require real time inventory in harsh environment on a shelf.
2. Liquids especially in healthcare applications with injectable drugs
3. Livestock visibility systems, especially in areas where many cattle must be identified one by one.
4. Applications that require data to be written to the tag, again especially in healthcare where many details linked to expiry date, serial numbers and lot numbers must be written to tag after it is applied to product.
5. Applications that require sensors or data logs
6. Applications that may require date and time stamps or digital signatures or proof of content to prevent counterfeiting.
7. Applications that require tags to be read over large areas with long ranges. Passive tags work well “on-axis” but require many transmitters to read a large area.

### SUMMARY OF THE INVENTION

Broadly and generally, the present invention provides an ultra low frequency (ULF) tag for detection and tracking of animate and inanimate objects attached thereto, the aforesaid ULF tag comprising:

a) a tag antenna operable at a low radio frequency below 1 megahertz;

b) a communication device operatively connected to the aforesaid tag antenna and operable to transmit data at the aforesaid low radio frequency;

c) a clock device operatively connected to the aforesaid communication device and operable to emit clock data to determine the aforesaid low radio frequency; and

d) a storedenergy storage device operable to activate the aforesaid communication device and the aforesaid clock device.

According to a preferred embodiment, the aforesaid clock device comprises a crystal operable to emit said clock data at a selected natural frequency. For example, the aforesaid low radio frequency (e.g. 128 kilohertz) can be a whole number multiple of the aforesaid natural frequency (e.g. 32 kilohertz).

Advantageously, the aforesaid tag antenna comprises a coil wound around a ferrite core.

Preferably, the aforesaid ULF tag further comprises:

e) a data storage device operable to store data comprising identification data for identifying the aforesaid ULF tag;

f) a data processor operable to process the aforesaid data received from the aforesaid communication device, the aforesaid data storage device, and the aforesaid clock device, and to transmit response data to cause the aforesaid communication device to emit an identification signal based on the identification data stored in the aforesaid data storage device, the aforesaid stored energy storage device comprising a battery operable to activate said data processor.

Advantageously, the aforesaid ULF tag further comprises a warning device (e.g. LCD screen, LED, buzzer) operable to identify the aforesaid ULF tag (e.g. by a visible message, warning light, or audible sound) upon emission of the aforesaid identification signal.

According to a preferred embodiment, the aforesaid ULF tag further comprises:

i) a data storage device operable to store data comprising identification data for identifying the aforesaid ULF tag;

ii) a sensor operable to generate status data upon sensing exposure to a condition;

iii) a data processor operable to process data received from the aforesaid sensor, the aforesaid storage device, and the aforesaid clock device, and to transmit data to cause the aforesaid communication device to emit data comprising the aforesaid status data together with an identification signal based on the identification data stored in the aforesaid data storage device, the aforesaid energy storage device comprising a battery operable to activate said data processor. Advantageously, the aforesaid condition may be selected from temperature, expiration of a freshness period, shock, illumination level, dampness, and radiation exposure.

Broadly and generally, the present invention further provides a system for detection and tracking of animate and inanimate objects, the aforesaid system comprising:

i) a ULF tag carried by each of the objects, the aforesaid ULF tag comprising:

a) a tag antenna operable at a low radio frequency below 1 megahertz (e.g. 128 kilohertz);

b) a communication device operatively connected to the aforesaid tag antenna and operable to transmit data at the aforesaid low radio frequency, the aforesaid communication device being operable to receive query data from the aforesaid tag antenna at the aforesaid low radio frequency,

c) a clock device (e.g. crystal) operatively connected to the aforesaid communication device and operable to emit clock data to determine said low radio frequency; and

d) a stored energy storage device operable to activate the aforesaid communication device and the aforesaid clock device;

e) a data storage device operable to store data comprising identification data for identifying the aforesaid ULF tag;

f) a data processor operable to process the aforesaid data received from the aforesaid communication device, the aforesaid storage device, and the aforesaid clock device, and to transmit response data to cause the aforesaid communication device to emit an identification signal based on the identification data stored in the aforesaid data storage device, the aforesaid stored energy storage device comprising a battery operable to activate the aforesaid data processor;

ii) a field antenna disposed at an orientation and within a distance from each object that permits effective communication with the ULF tag thereof at the aforesaid low radio frequency,

iii) a field reader in operative communication with said field antenna, the aforesaid field reader being operable to send query data to, and to receive data from, the aforesaid ULF tag;

iv) a central data processor in operative communication with the aforesaid field reader and operable to process data received therefrom.

Preferably, the aforesaid tag antenna comprises a coil wound around a ferrite core and the aforesaid ULF tag further comprises a warning device operable to identify the aforesaid ULF tag upon emission of the aforesaid identification signal.

According to a preferred embodiment, the aforesaid ULF tag further comprises a sensor operable to generate status data upon sensing exposure to a condition; the aforesaid data processor being operable to process data received from the aforesaid sensor, the aforesaid data storage device, and the aforesaid clock device, and to transmit data to cause the aforesaid communication device to emit data comprising the aforesaid status data together with an identification signal based on the identification data stored in the aforesaid data storage device. Advantageously, the aforesaid condition may be selected from temperature, expiration of a freshness period, shock, illumination level, dampness, and radiation exposure.

According to another preferred embodiment, the aforesaid system comprises a plurality of ULF tags, each ULF tag being characterized by an aforesaid natural frequency that comprises a random characteristic variation in at least one of phase and amplitude, said characteristic variation being capable of distinguishing a selected the aforesaid ULF tag from other aforesaid ULF tags.

The present invention broadly and generally also provides a method for detection and tracking of animate and inanimate objects, the aforesaid method comprising the steps of:

a) attaching a ULF tag to each of the objects, each ULF tag comprising a tag antenna operable at a low radio frequency below 1 megahertz; a communication device operatively connected to the aforesaid tag antenna and operable to transmit data at the aforesaid low radio frequency; a clock device operatively connected to the aforesaid communication device and operable to emit clock data at a selected natural frequency to determine the aforesaid low radio frequency, each ULF tag being characterized by an aforesaid natural frequency that comprises a random characteristic variation in at least one of phase and amplitude, the aforesaid characteristic variation being capable of distinguishing a selected aforesaid ULF tag from other aforesaid ULF tags; a data storage device operable to store data comprising identification data for identifying the aforesaid ULF tag; a data processor operable to process said data received from the aforesaid communication device, the aforesaid data storage device, and the aforesaid clock device, and to transmit response data to cause the aforesaid communication device to emit an identification signal based on the identification data stored in said data storage device; and an energy storage device operable to activate the aforesaid communication device, the aforesaid clock device, and the aforesaid data processor;

b) storing, in the data storage device of each ULF tag, data comprising identification data for identifying the aforesaid ULF tag;

c) disposing a field antenna at an orientation and within a distance from each object that permits effective communication with the ULF tag thereof at the aforesaid low radio frequency;

d) reading the data from the data storage device of a ULF tag selected by sending a query at an aforesaid radio frequency below 1 megahertz characterized by an aforesaid characteristic variation thereof;

e) transmitting the data read from the selected tag to a central data processor to provide a tally of the aforesaid objects;

f) sending a signal to the selected ULF tag to temporarily turn off further transmission from the aforesaid selected ULF tag; and

g) repeating steps (d), (e), and (f) with different aforesaid characteristic variations to discover and tally all the aforesaid objects.

Preferably, each aforesaid ULF tag may comprise a sensor operable to generate status data upon sensing a condition (as exemplified hereinabove), the aforesaid data processor being operable to process the status data received from the aforesaid sensor and to emit data comprising the aforesaid status data together with the aforesaid identification data for receipt thereof by the aforesaid field antenna.

The invention further provides a system for communicating with hearing-impaired people, the aforesaid system comprising:

i) a hearing aid device carried at an ear of each of the people, the aforesaid hearing aid device comprising:

a) a tag antenna operable at a low radio frequency below 1 megahertz, the aforesaid tag antenna preferably comprising a coil wound around a ferrite core;

b) a communication device operatively connected to the aforesaid tag antenna and operable to receive data therefrom at the aforesaid low radio frequency,

d) an energy storage device operable to activate said communication

ii) a field antenna disposed at an orientation and within a distance from each of the people that permits effective communication with the hearing aid device thereof at the aforesaid low radio frequency,

iii) a field transmitter in operative communication with the aforesaid field antenna, the aforesaid field reader being operable to send data to the aforesaid hearing aid device; Preferably, the aforesaid field antenna may be a loop antenna, which can advantageously be large, as discussed and exemplified with respect to FIGS. 12 and 13.

### BRIEF DESCRIPTION OF THE DRAWINGS

For a better understanding of the invention, various features of preferred embodiments of the novel system, method, and tag, are illustrated in the drawings, as will be described hereinbelow:

FIG. 1 is a schematic plan view of a ULF tag in accordance with an embodiment of the invention;

FIG. 2 is a schematic cross-sectional view of the ULF tag of FIG. 1;

FIG. 3 is a schematic perspective view of a ULF tag in the cap of a bottle, in accordance with a second embodiment of the invention;

FIG. 4 is a schematic perspective view of a ULF tag in the bottom of a bottle, in accordance with a third embodiment of the invention;

FIG. 5 is a schematic of a passive RF tag and a proximity antenna, showing voltage variation for HF and ULF tags;

FIG. 6 is a schematic of a passive RF tag and a proximity antenna, showing cost variation for HF and ULF tags;

FIG. 7 is a schematic of a passive RF tag and a proximity antenna, showing variation in speed of reading and writing for HF and ULF tags;

FIG. 8 is a chart showing variation in signal strength for antennas of different diameters with distance;

FIG. 9 is a chart showing variation in signal strength for a proximity antenna of different diameters with distance;

FIG. 10 is a chart showing variation in signal strength for a loop antenna with distance;

FIG. 11 is a chart showing variation in signal strength for both proximity and loop antennas with distance;

FIG. 12 is a schematic of loop antennae of different sizes, together with corresponding frequencies;

FIG. 13 is a schematic of loop antennae of different shapes and sizes;

FIG. 14 is a schematic of a loop antenna and reader, together with phase variations of one tag frequency and reader frequency;

FIG. 15 is a schematic of a loop antenna and reader, together with phase and amplitude variations among four tags' frequencies;

FIG. 16 is a list of three tags' identification (ID) numbers and their corresponding checksums;

FIG. 17 is a flowchart using block diagrams to describe the use of the invention to discover tags within range of a field loop antenna;

FIG. 18 is a schematic view depicting the use of the invention to discover tags within range of a field loop antenna;

### DETAILED DESCRIPTION OF PREFERRED EMBODIMENTS

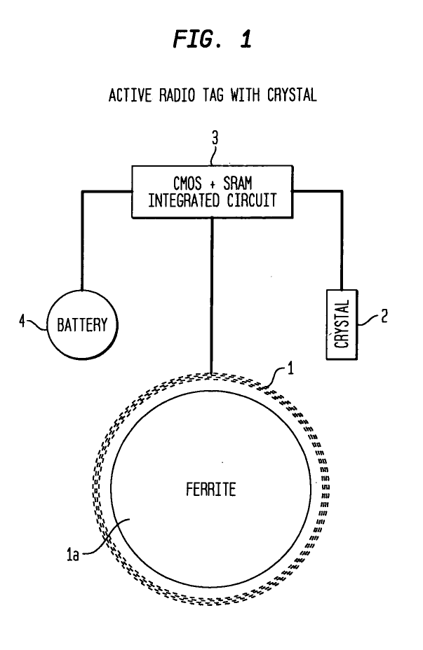

FIG. 1 is a schematic block diagram of an ULF (Ultra Low Frequency) active low frequency tag in accordance with the present invention. A battery 4 can be a Lithium or alkaline battery, (LR44) and may cost as low as 5.5 cents. A CMOS integrated circuit 3 that in the preferred embodiment will contain SRAM. 2. Crystal 2 used for timing. In the preferred embodiment, crystal 2 is a low cost 32 Khz watch crystal that is multiplexed 4×. This may optionally be replaced with an oscillator designed as part of the CMOS chip circuitry. An antenna 1 can be wire wound around a ferrite 1a or be an open loop antenna. The loop radius may be as small as a few mm, or may be 12 inches or larger depending upon the application.

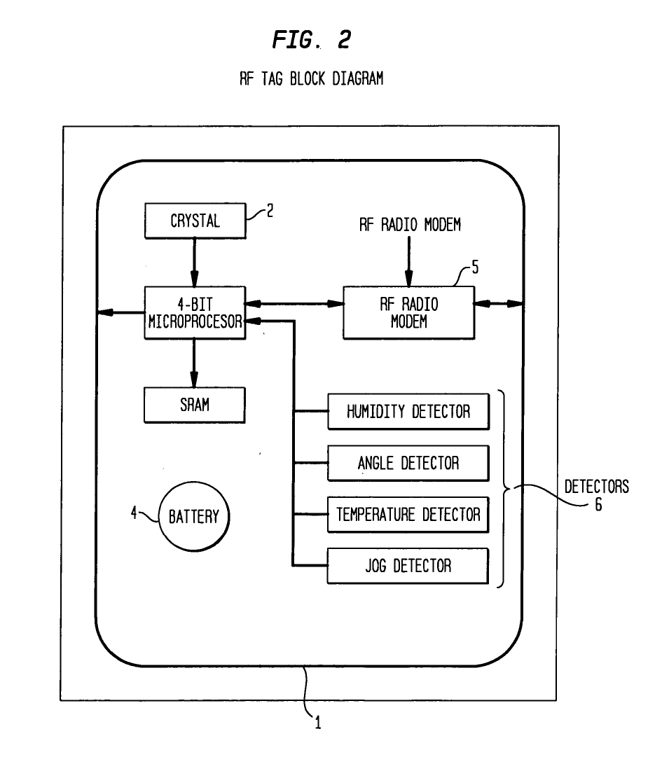

FIG. 2

Block Diagram of a more complex radio tag. In this example we may add a low cost 4 bit microprocessor so the tag can be programmed. The processor may connect to the RF radio modem 5. In addition detectors 6 for humidity, angle, temperature and jog can be added. LEDS (not shown)e and displays may also optionally be added.

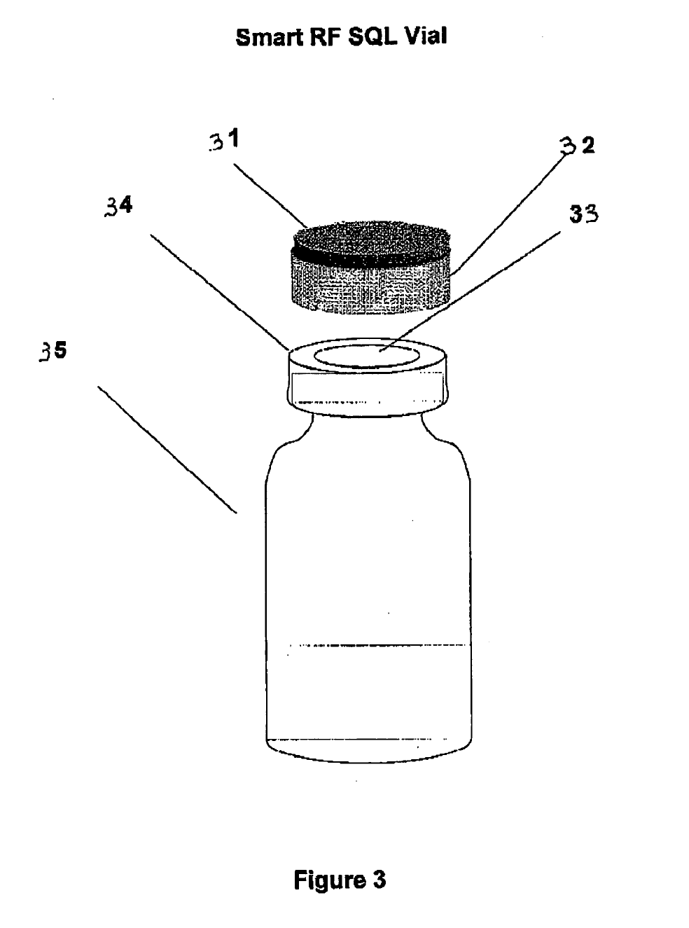

FIG. 3

A typical application for these ULF tags may be specialty pharmaceuticals with an injectable vial 35 and a tag 31 placed on the cap 32. In this case, the vial, about 15 mm in diameter, contains liquid that will interfere with UHF as well as UHF-interfering metal in the crimped cap 32 and 34. Other HF tags would not work reliably because of the metal. Moreover the FDA has recommended that these tags store information about the product (serial number, lot number expiry date) after the tag 31 has been placed on the vial 35. Thus the tag requires memory and must work near metal and liquids.

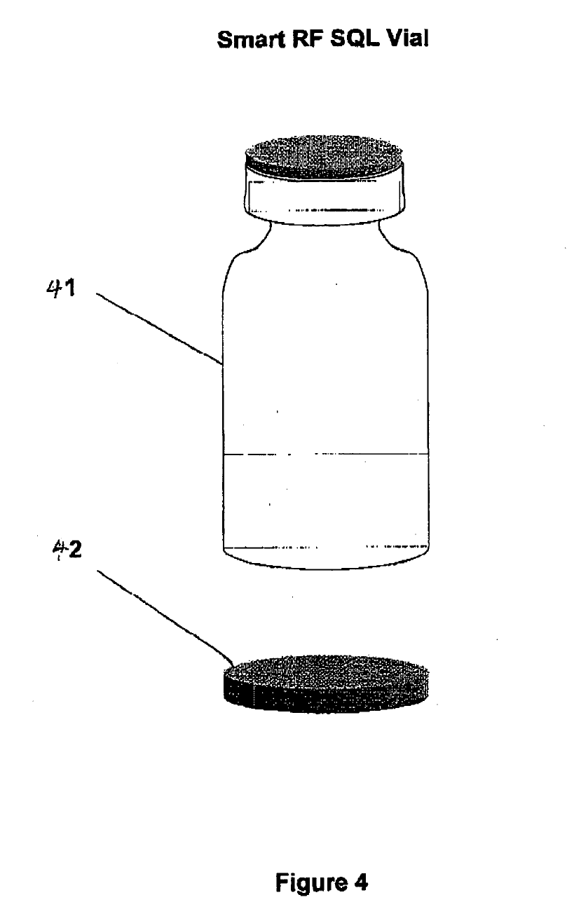

FIG. 4

An alternative location for placing the tag 42 might be on the bottom of the vial 41. In some cases an HF tag might function, however the antenna dimensions would be small (about 15 mm in diameter) and would be very short range. UHF would also not work in this configuration because of the liquid in contact with the bottom of the vial. The ULF tag disclosed in this patent application, with a wire coil and ferrite, can function from a distance of many feet and in any orientation in this configuration and in the configuration shown in FIG. 3.

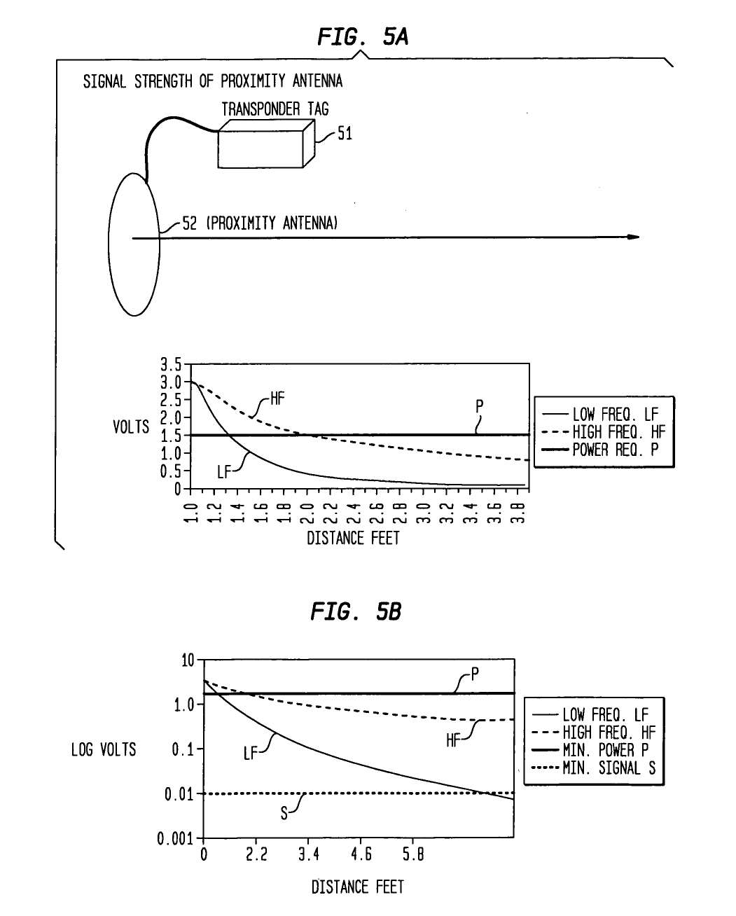

FIG. 5

FIG. 5 shows a typical proximity antenna 52 using a passive transponder tag 51. We show the expected signal as a function of distance from the antenna. In the upper graph we show the minimum power P required to keep the logic on the integrated circuit functioning. The upper line HF on the graph is the expected signal strength for an electric filed signal at high frequency (or UHF) as a function of distance. (drops off as 1/d²) and the lower line is the expected signal for a magnetic field LF (drops off 1/d³). The lower graph is the same plot on a log scale but also includes the minimum signal that can be read using a simple amplifier with wide dynamic range and ability to read signals over four decades (10 MV-10 Volts) we can obtain a read range of 7 feet using magnetic signal, as opposed to a passive tag and high frequency HF that can transmit only two feet because it loses power at that point. It would be possible to construct an active tag with a battery at these higher frequencies, however because the logic must operate at high frequencies the power consumption is high and the battery life is quit short. Thus an active tag with a battery at low frequencies can have a much longer range and also have long battery life (10-15 years) providing it has a wide dynamic range amplifier. This also provides the tag with some immunity from loss of function as the coil is rotated at an angle from the field.

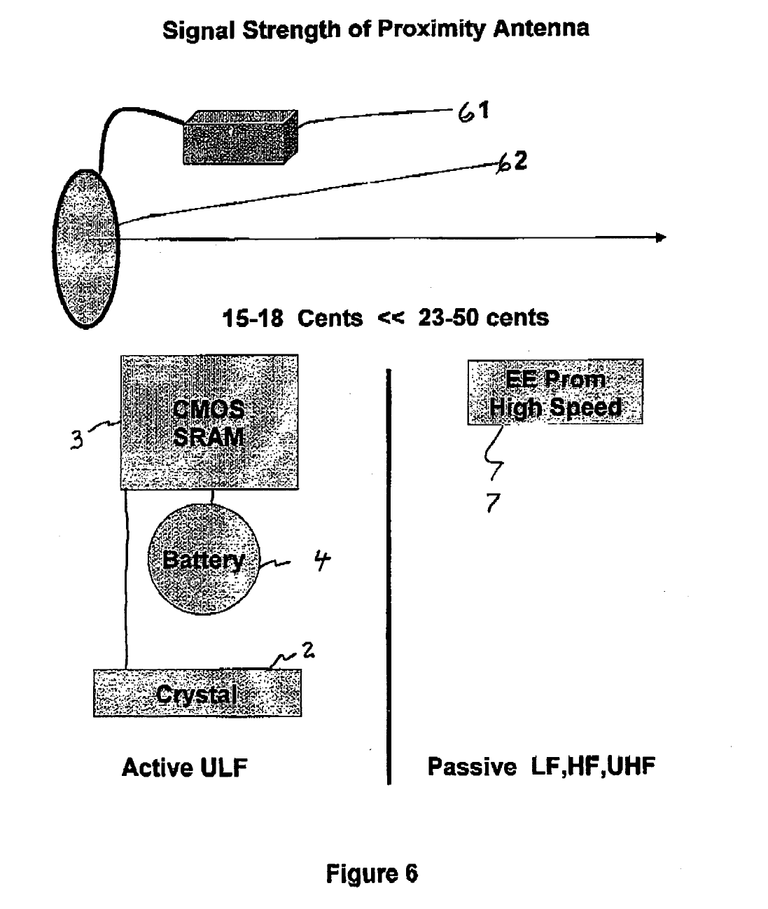

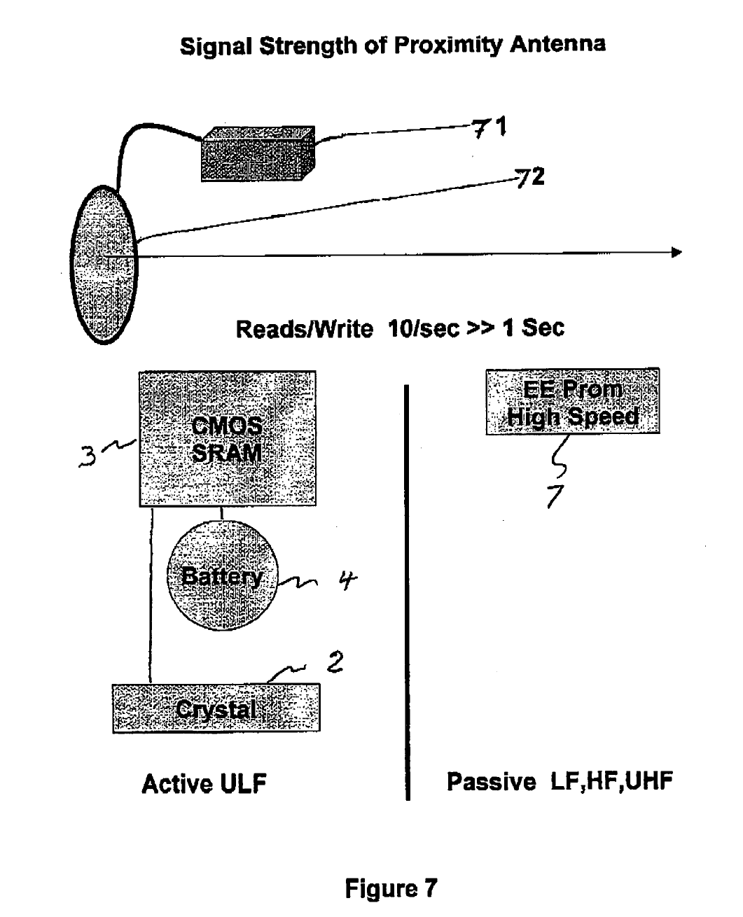

FIG. 6 and FIG. 7

Many passive RFID tags have requirement to store data in the tag. In all cases they must use EEPROM since they have no battery to power SRAM or DRAM 3. An EEPROM requires many extra steps in the processing of its chip wafer and also increases the area of the chip itself by about 60% over what would be required by SRAM. Thus EEPROM raises the cost of a chip in a passive RFID tag. A ULF frequency active tag operates at such low frequency and as a result may use metal gate CMOS or optionally silicon gate CMOS. This has the advantage of low power consumption and low fabrication cost of the chip. In most cases the cost of the battery (6 cents), and a crystal (4 cents) and CMOS chip (5-10 cents) is less than a EEPROM chip with less than 24 bytes of memory. In addition the write speed with a EEPROM device is very slow compared to SRAM. The communication speed of the ULF active tag is slow (1200 to 4800 baud) however the write time of EEPROM makes it possible for it operate faster and have a lower materials cost. Thus, as shown in FIGS. 6,7, a low frequency active tag 61,71 with antenna 62, 72, respectively, may, in fact, have better speed performance at a lower cost when memory is required for storage of any data.

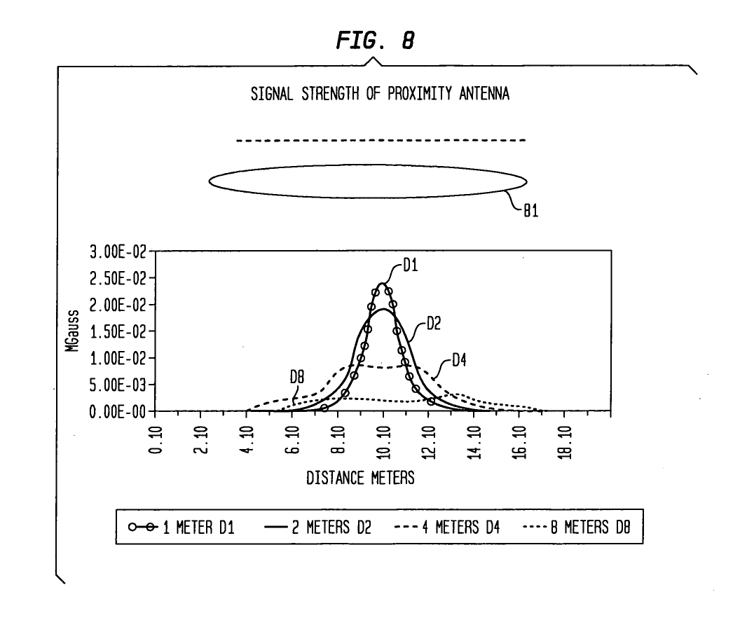

FIG. 8

In most cases the base station or reader antenna signal strength is measured axially from the center of the antenna. When inductive or magnetic fields are measured one meter from the antenna with a constant voltage at 100 Khz (1 volt) placed on the loop antenna 81, the strength of the signal decreases as the antenna diameter increases. This graph is the outputs D1, D2, D4, and D8 at 100 Khz for a readily available simulation program (MOMAC) for a 1 Meter, 2 meter, 4 meter, and 8 meter field loop.

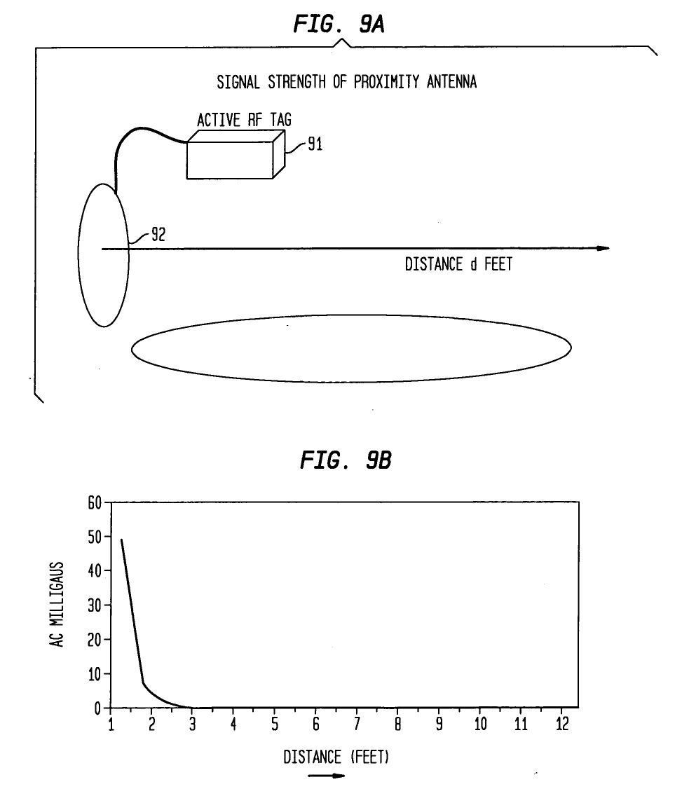

FIG. 9

When the signal strength is measured as a function of distance it drop off along the axis of an antenna 92 as 1/d³. The graph in FIG. 9 is based on actual measurements using a tunned 1 meter coil antenna at 132 Khz. An active RF tag 91 may function out to five feet where the signal is above 10 milligauss.

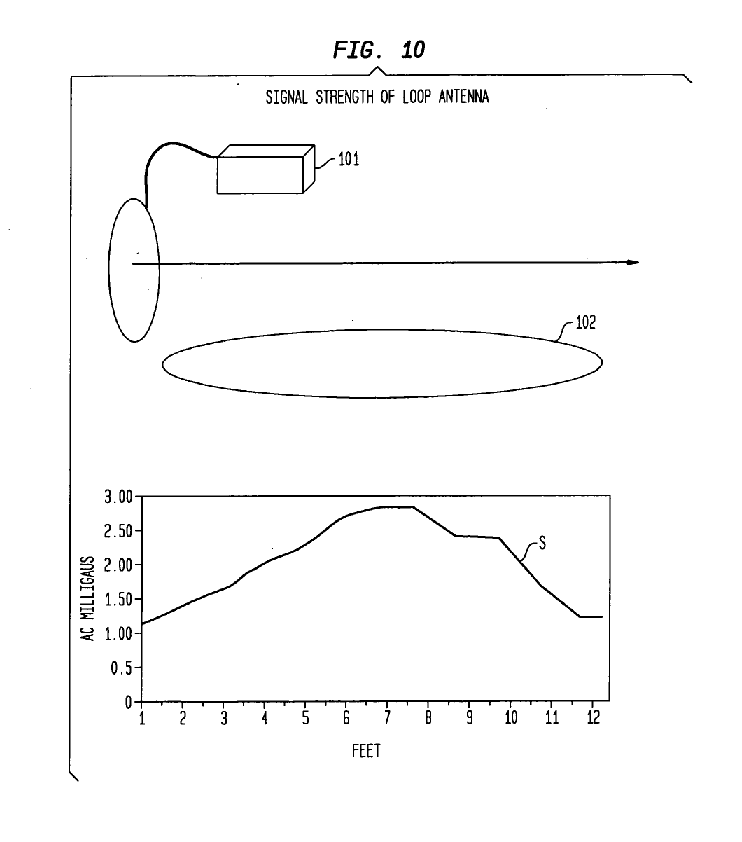

FIG. 10

An omni-directional loop antenna 102, placed horizontally on the floor and having a radius of 8 feet, produces a strong signal S over that entire area. A tag 101 may be read anywhere within the area of the loop plus the same distance outside the loop at the same distance found for FIG. 9. In other words in an area with a diameter of 18 feet.

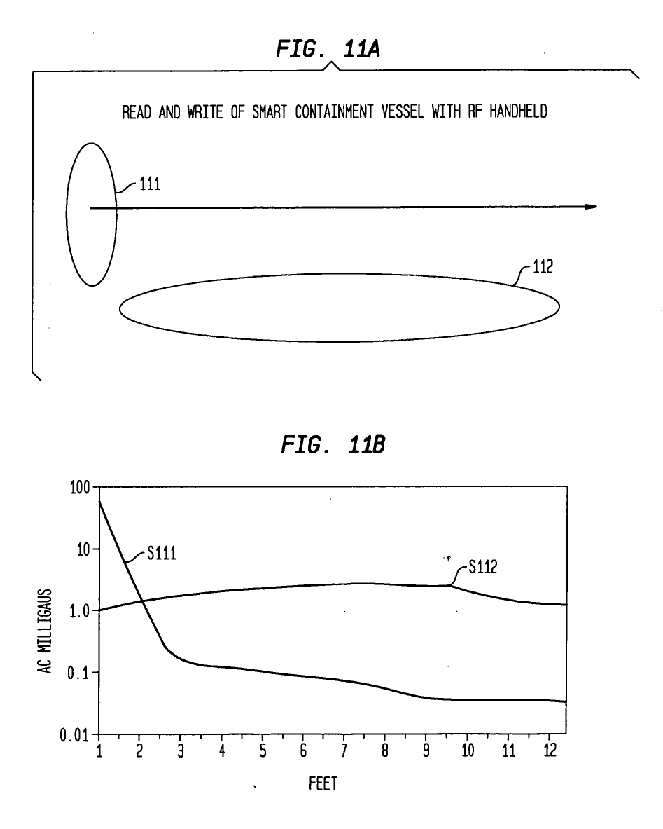

FIG. 11

FIG. 11 shows a log comparison of an on-axis signal S111 detected by a 1 meter loop signal and a signal 112 detected by a 9 foot floor area loop antenna. A tag may be read anywhere within the area of the floor loop plus about five feet beyond the edge.

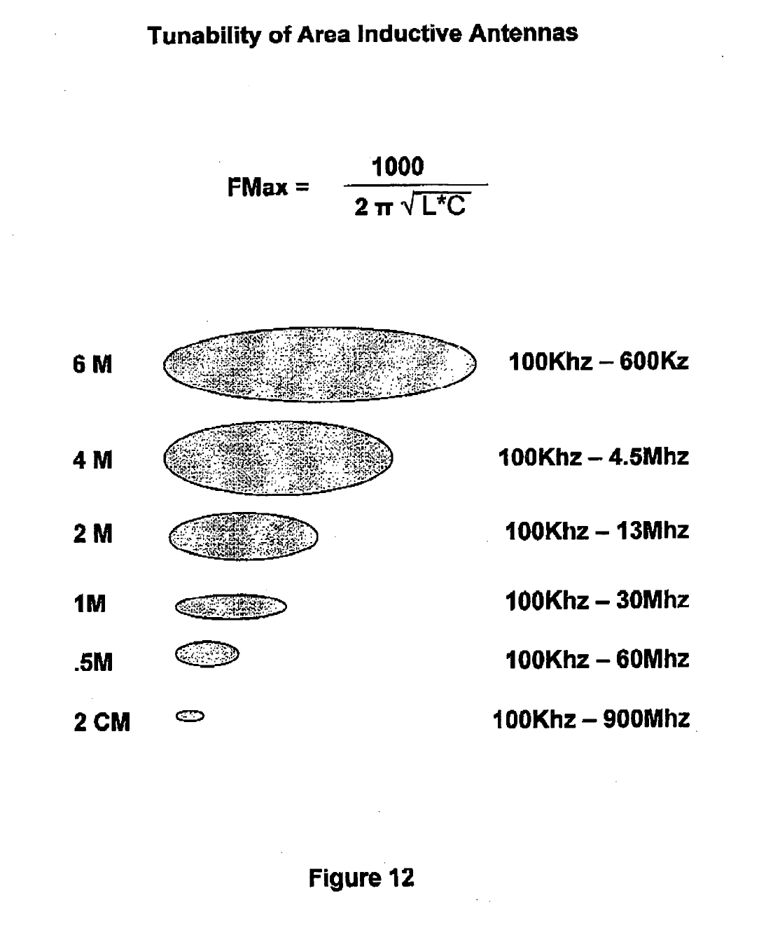

FIG. 12

The area or size of a loop than can be tuned is limited by the intrinsic capacitance C and inductance L of a loop antenna. As the loop becomes larger these two values go up and the maximum tunable frequency goes down for a magnetic field. The advantage of using the magnetic field over electric field for communication is that the magnetic field is relatively immune to steel and liquids. The electric field can be absorbed by liquids and reflected or blocked by any conductive metal. The distance transmitted using a loop antenna is totally dependent upon size of the loop, and the size of the loop is inverse of maximum tunable frequency. Thus, much longer transmission distance may be obtained with lower frequencies when using the magnetic field.

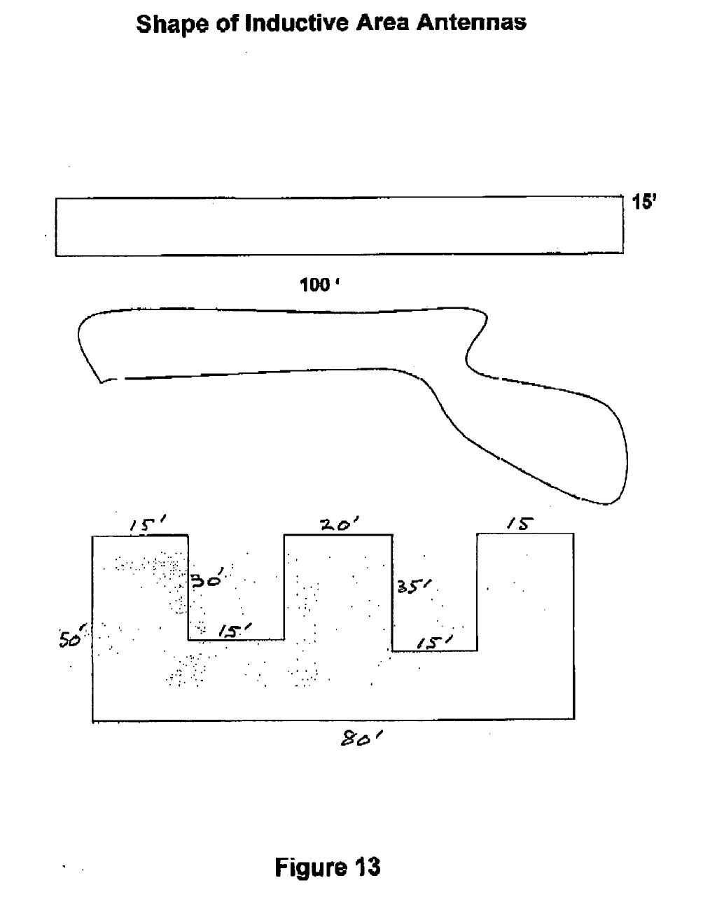

FIG. 13

As a practical limit the field loops for ULF can be up to 150×150 feet in area and may, as shown in FIG. 13, be placed in almost any shape to maximize the filed with that area. When large areas must be covered it is possible to create an array of overlapping loops hooked up to separate base stations or multiplexed by a single base station.

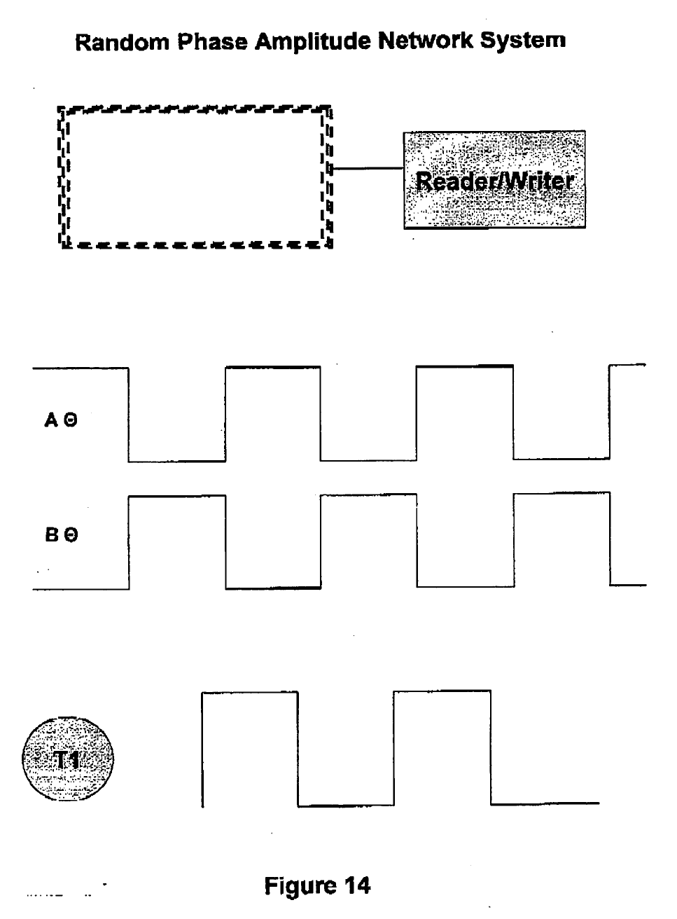

FIG. 14

One of the unexpected advantages of the crystal in an active ULF tag is that it provides a random phase for each tag T1 making it possible to read a single tag's ID even though many tags may respond. The base station has filters the operate a two phases 180 degrees shifted and each phase has its own amplifier. Tags transmit to the A channel and B channel at the same time and the base station simply picks the channel that provides the greatest amplitude.

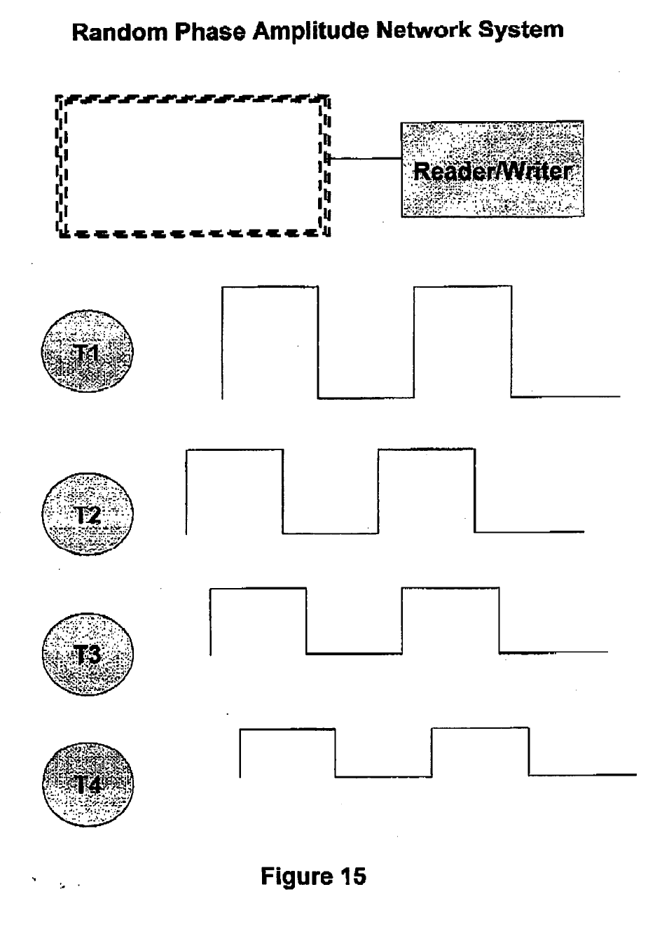

FIG. 15

In a field with many tags T1, T2, T3, and T4, all with different phases and at different amplitudes, because they are at different distances one tag will “win” and the ID can be read correctly. This tag is addressed using the discovered ID and then turned off. Then the next group of tags is interrogated and so on until all Ids are discovered. This works efficiently for a field of 50-100 tags.

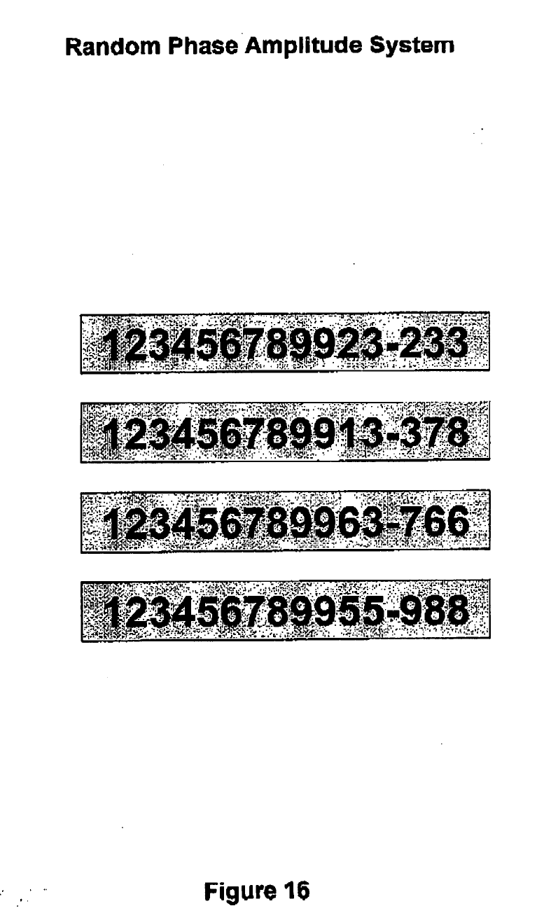

FIG. 16

FIG. 16 shows tag ID's with checksums

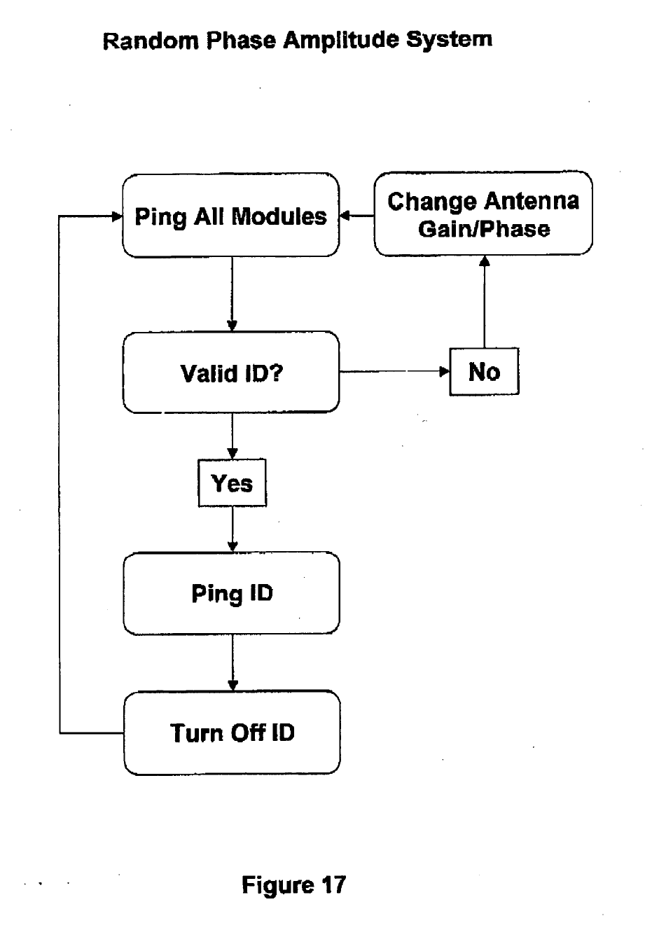

FIG. 17

FIG. 17 shows the flow chart for discovery of an ID (using checksums for validation of tag ID's).

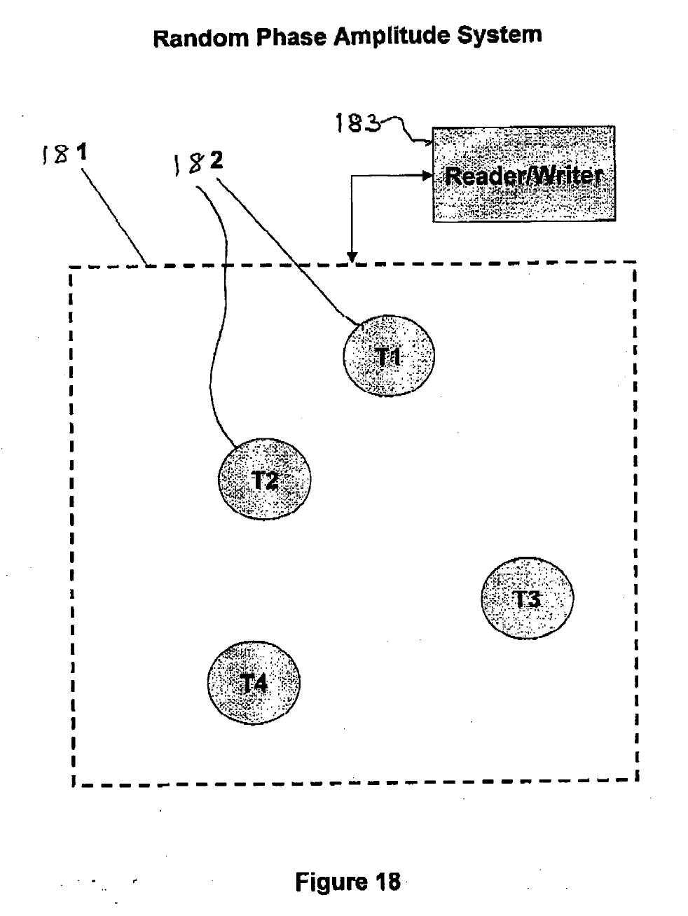

FIG. 18

FIG. 18 shows an area loop antenna 181 with tags 182 in its field that can be discovered by use of a reader 183.

It will be understood that the present invention provides an integrated “visibility system” that overcomes many of the objections described above for ULF systems and overcomes many of the problems outlined for HF and UHF in many applications. The visibility system tag has the capability of high memory capacity (e.g. 8 K Bytes), full data logs, temperature monitoring, optional LED's and LCD displays. These tags do not use the transponder method of communication's and actually transmit a signal through a tuned antenna using induction. Because the tags work at relatively low frequencies they do not require much power and have a battery life of 10 to 15 years using a 300 MAH lithium battery. They may store data that might normally be contained in a database, can be read anywhere within an open area up to 150 feet by 150 feet or a defined area of 15 feet by 500 feet. In effect we have read ULF tags at distances of over 500 feet with this system. In the preferred embodiment the ULF tags can write stored data in some cases at higher speeds than current HF and UHF tags.

The system uses a low cost active ULF radio tag, a novel antenna design optimized for long range area reads and inductive communication for tracking products, and providing real time visibility of products, especially products that require provide real time inventory of products, and real time status of products in harsh environments. The tags maybe small and often have a lower direct cost than passive RF tags, and can reduce systems cost by eliminating much of the IT software required for passive tags.

Examples of uses of the tags is:
1. Real time visibility systems for medical devices, and pharmaceuticals on shelves in hospital.
2. Real time visibility systems for medical devices, and pharmaceuticals as they are distributed throughout the supply chain. in trucks and warehouses.
3. Real time visibility systems for livestock This radio tag may optionally have active storage memory, overcomes many of the range, angle and costs issues outlined above as well as networking issues. This tag transmission is in the ULF range and is in compliance with FCC Part IS regulations between 8 KHz and 500 Khz. In a preferred embodiment, the active ULF tag transmits and receives using a frequency of 128 Khz:
4. Real time visibility system in hospitals for patients, nurses and physicians. Each patient may be provides with an active wrist band that can be read within an area. Data about the patient may be stored in the wrist tag. Similar systems may be created for physician using an ID tag.

The ULF tag System's unique features are:
1. A battery (or other energy storage device or other energy storage device) to power the logic, memory and other circuitry as well as to enhance the power of the transmission to and from a reader. The battery also serves as power for optional detectors and sensors, as well as LCD's and LED's.
2. A crystal to provide a frequency reference. In the preferred embodiment we use a 32 Khz crystal commonly used in watches or devices that require a timing standard. This is used as a frequency reference for transmission, date and time. The crystal serves as a timing reference or clock for recording date and time. This makes it possible for the tag to create logs and records of temperature humidity and other parameters. It also provides for a dynamic proof of content that can be changed every period of time. The crystal also provides for the ability for the tag to become an “on-demand” client to transmit when a specific condition is met or an optional sensor value is exceeded without the need of a reference carrier. The crystal frequency may be multiplied 4 times to achieve a transmission frequency of 128 Khz.
3. The crystal also provides for random phase between each module. Passive and other active tags all use a transponder mode and use carrier frequency as a reference. The crystal is viewed as unnecessary in other tags and is eliminated to save costs and space. However, the crystal unexpectedly provides for the ability to selectively read one tag within an area, without prior knowledge of its ID. This random phase and “network discovery” is enabled by the use of the crystal as opposed to anti-collision methods used in other radio tags.
4. Low power logic, and communications circuitry (a radio modem) that makes use of standard complementary metal oxide semiconductor or CMOS. CMOS is a widely used type of semiconductor. CMOS semiconductors use both NMOS (negative polarity) and PMOS (positive polarity) circuits. Since only one of the circuit types is on at any given time, CMOS chips require less power than other chips. The power consumption of static CMOS logic is directly proportional to switching frequency. HF and UHF tags can use batteries to enhance power but because of the higher speeds required, and typical need for high bandwidth, the battery life is limited.
5. Memory or storage means attached or contained in the circuitry described under point 3 immediately above using static or dynamic storage systems also based on CMOS designs and powered by battery under “1” with timing and logic functions based on the crystal, described under point 2 immediately above.
6. A wide dynamic range amplifier on the tag makes it angel insensitive and also enhances the range of the tag. This is possible due to battery and independent frequency reference.
7. A coil or loop antenna attached to the CMOS radio modem that has been wound to achieve maximum signal strength. The coil may have a capacitor in series for optimal tunning.
8. Optional sensors for light, temperature, acceleration, humidity etc.
9. Optional LED's to signal or indicate that one particular radio tag should be selected over another tag.
10. Optional Display to display information linked to a product, such as the product ID number or expiry date, or lot number etc.
11. A reader or base station consisting of logic circuitry, a radio modem circuit, a and a loop antenna. The loop antenna may consist of medium gauge wire (10-12 gauge) with several turns of wire around the loop and it can be placed on the perimeter around a room or a metal shelf for example so the radio tags may be read and written to within that loop area. The distance the tag is read maybe controlled by the size of the loop. For example the loop maybe small, a foot by one foot, and a tag maybe read or written to with that area and within several feet surrounding the area. Alternatively, the loop may cover a large area, 100×100 feet for example. In this case a radio tag maybe read or written to anywhere within the 100 sq foot area, as well as 20 to 30 feet beyond the loop's edge outside of the central area.
12. In public areas the same loop antennas may also be used as an Assisted Listening Systems (ALS) system. Similar loop antenna systems have been used to inductively broadcast analog audio signals within an area (U.S. Pat. No. 3,601,550, U.S. Pat. No. 3,426,151) and audio from store windows to hearing aids as disclosed in EP0594375A2. These antennas are widely used in Europe and Japan, with limited use in the US for ALS. These ALS systems most often that make use of t-Coils placed in hearing aids. A “t-coil” is an inductive loop often with a ferrite core, optionally placed in a hearing aid that can pick up low frequency audio signals in a room. The low frequency audio signal placed on the inductive loop is picked up directly by the t-coil and magnified by the hearing aid with little or no power penalty. In contrast to other radio antennas with signals that drop off with distance, the loop antennas discussed hereinabove offer at these frequencies a strong and relatively homogeneous magnetic filed over a large area (up to 10,000 sg feet) with effective read/write distances of over 100 feet.

In brief, some advantages/features of the novel ULF tags include:

POC time reference

No hand held—issues

EPC global

wrist bands—touch less reads.

medicines dispensing

human visibility

noise reduction and location identification

area antenna vs directional antenna

omindirectional

Active high frequency radio tags overcome many of these objections, especially the transmission distance issue, and in many cases they can be designed to function in harsh environments using advanced communication algorithms (e.g. Spread Spectrum), the memory speed issues may be addressed using high speed static memory, and finally these active tags may use. However active LF, HF and UHF tags have two major disadvantages: First, since the power consumption of any solid state circuit is proportional to the operating speed, active LF,HF and UHF tags require large batteries with limited life (two to maximum five years) and as a result are bulky heavy devices; Second, they must use high speed semiconductor devices that have a major impact on the active tag costs as compared to other semiconductor processes that operate at lower frequencies. Since, these high speed semiconductor devices require many more fabrication steps over lower cost commodity processes such as static metal gate CMOS (8 steps vs maybe 22 steps) for a silicon wafer these cost disadvantages of LF,HF and UHF active tags are fundamental and will always be an issue.

While the present invention has been described with reference to preferred embodiments thereof, numerous obvious changes and variations may readily be made by persons skilled in the fields comprising radio frequency transmission, RFID tags, logistics, and impaired hearing. Accordingly, the invention should be understood to include all such variations to the full extent embraced by the claims.

What is claimed is:

1. An ultra low frequency (ULF) tag for detection and tracking of animate and inanimate objects attached thereto, said ULF tag comprising:
a) a tag antenna operable at a low radio frequency below 1 megahertz;
b) a communication device operatively connected to said tag antenna and operable to transmit data at said low radio frequency;
c) a clock device operatively connected to said communication device and operable to emit clock data to determine said low radio frequency; and
d) an energy storage device operable to activate said communication device and said clock device.

2. A ULF tag as set forth in claim 1, said clock device comprising a crystal operable to emit said clock data at a selected natural frequency.

3. A ULF tag as set forth in claim 2, said low radio frequency being a whole number multiple of said natural frequency.

4. A ULF tag as set forth in claim 3, said low radio frequency being 128 kilohertz and said natural frequency being 32 kilohertz.

5. A ULF tag as set forth in claim 1, said tag antenna comprising a coil wound around a ferrite core.

6. A ULF tag as set forth in claim 1, said communication device being operable to
receive query data from said antenna at said low radio frequency, said ULF tag further comprising:
e) a data storage device operable to store data comprising identification data for identifying said ULF tag;
f) a data processor operable to process said data received from said communication device, said storage device, and said clock device, and to transmit response data to cause said communication device to emit an identification signal based on the identification data stored in said data storage device, said energy storage device comprising a battery operable to activate said data processor.

7. A ULF tag as set forth in claim 6, said clock device comprising a crystal operable to emit said clock data at a selected natural frequency.

8. A ULF tag as set forth in claim 7, said low radio frequency being a whole number multiple of said natural frequency.

9. A ULF tag as set forth in claim 8, said low radio frequency being 128 kilohertz and said natural frequency being 32 kilohertz.

10. A ULF tag as set forth in claim 6, said tag antenna comprising a coil wound around a ferrite core, said ULF tag further comprising a warning device operable to identify said ULF tag upon emission of said identification signal.

11. A ULF tag as set forth in claim 1, said ULF tag further comprising:
i) a data storage device operable to store data comprising identification data for identifying said ULF tag;
ii) a sensor operable to generate status data upon sensing exposure to a condition;
iii) a data processor operable to process data received from said sensor, said storage device, and said clock device, and to transmit data to cause said communication device to emit data comprising said status data together with an identification signal based on the identification data stored in said data storage device, said energy storage device comprising a battery operable to activate said data processor.

12. A ULF tag as set forth in claim 11, said clock device comprising a crystal operable to emit said clock data at a selected natural frequency.

13. A ULF tag as set forth in claim 12, said low radio frequency being a whole number multiple of said natural frequency.

14. A ULF tag as set forth in claim 13, said low radio frequency being 128 kilohertz and said natural frequency being 32 kilohertz.

15. A ULF tag as set forth in claim 11, said tag antenna comprising a coil wound around a ferrite core, said ULF tag further comprising a warning device operable to identify said ULF tag upon emission of said identification signal.

16. ULF tag as set forth in claim 11, said condition being selected from temperature, expiration of a freshness period, shock, dampness, and radiation exposure.

17. A system for detection and tracking of animate and inanimate objects, said system comprising:
i) a ULF tag carried by each of the objects, said ULF tag comprising:
a) a tag antenna operable at a low radio frequency below 1 megahertz;
b) a communication device operatively connected to said tag antenna and operable to transmit data at said low radio frequency, said communication device being operable to receive query data from said tag antenna at said low radio frequency,
c) a clock device operatively connected to said communication device and operable to emit clock data to determine said low radio frequency; and
d) an energy storage device operable to activate said communication device and said clock device;
e) a data storage device operable to store data comprising identification data for identifying said ULF tag;
f) a data processor operable to process said data received from said communication device, said storage device, and said clock device, and to transmit response data to cause said communication device to emit an identification signal based on the identification data stored in said data storage device, said energy storage device comprising a battery operable to activate said data processor;
ii) a field antenna disposed at an orientation and within a distance from each object that permits effective communication with the ULF tag thereof at said low radio frequency,
iii) a field reader in operative communication with said field antenna, said field reader being operable to send query data to, and to receive data from, said ULF tag;
iv) a central data processor in operative communication with said field reader and operable to process data received therefrom.

18. A system as set forth in claim 17, said clock device comprising a crystal operable to emit said clock data at a selected natural frequency.

19. A system as set forth in claim 18, said low radio frequency being a whole number multiple of said natural frequency.

20. A system as set forth in claim 19, said low radio frequency being 128 kilohertz and said natural frequency being 32 kilohertz.

21. A system as set forth in claim 17, said tag antenna comprising a coil wound around a ferrite core, said ULF tag further comprising a warning device operable to identify said ULF tag upon emission of said identification signal.

22. A system as set forth in claim 17, said ULF tag further comprising a sensor operable to generate status data upon sensing exposure to a condition; said data processor being operable to process data received from said sensor, said storage device, and said clock device, and to transmit data to cause said communication device to emit data comprising
said status data together with an identification signal based on the identification data stored in said data storage device.

23. A system as set forth in claim 22, said clock device comprising a crystal operable to emit said clock data at a selected natural frequency.

24. A system as set forth in claim 23, said low radio frequency being a whole number multiple of said natural frequency.

25. A system as set forth in claim 24, said low radio frequency being 128 kilohertz and said natural frequency being 32 kilohertz.

26. A system as set forth in claim 22, said tag antenna comprising a coil wound around a ferrite core, said ULF tag further comprising a warning device operable to identify said ULF tag upon emission of said identification signal.

27. A system as set forth in claim 22, said condition being selected from temperature, expiration of a freshness period, shock, dampness, and radiation exposure.

28. A system as set forth in claim 17, said system comprising a plurality of ULF tags, each ULF tag being characterized by a said natural frequency that comprises a random characteristic variation in at least one of phase and amplitude, said characteristic variation being capable of distinguishing a selected said ULF tag from other said ULF tags.

29. A method for detection and tracking of animate and inanimate objects, said method comprising the steps of:
a) attaching a ULF tag to each of the objects, each ULF tag comprising a tag antenna operable at a low radio frequency below 1 megahertz; a communication device operatively connected to said tag antenna and operable to transmit data at said low radio frequency; a clock device operatively connected to said communication device and operable to emit clock data at a selected natural frequency to determine said low radio frequency, each ULF tag being characterized by a said natural frequency that comprises a random characteristic variation in at least one of phase and amplitude, said characteristic variation being capable of distinguishing a selected said ULF tag from other said ULF tags; a data storage device operable to store data comprising identification data for identifying said ULF tag; a data processor operable to process said data received from said communication device, said data storage device, and said clock device, and to transmit response data to cause said communication device to emit an identification signal based on the identification data stored in said data storage device; and an energy storage device operable to activate said communication device, said clock device, and said data processor;
b) storing, in the data storage device of each ULF tag, data comprising identification data for identifying said ULF tag;
c) disposing a field antenna at an orientation and within a distance from each object that permits effective communication with the ULF tag thereof at said low radio frequency;
d) reading the data from the data storage device of a ULF tag selected by sending a query at a said radio frequency below 1 megahertz characterized by a said characteristic variation thereof;
e) transmitting the data read from the selected tag to a central data processor to provide a tally of said objects;
f) sending a signal to the selected ULF tag to temporarily turn off further transmission from said selected ULF tag; and
g) repeating steps (d), (e), and (f) with different said characteristic variations to discover and tally all said objects.

30. method as set forth in claim 29, said clock device comprising a crystal operable to emit said clock data at a selected natural frequency.

31. A method as set forth in claim 30, said low radio frequency being a whole number multiple of said natural frequency.

32. A method as set forth in claim 31, said low radio frequency being 128 kilohertz and said natural frequency being 32 kilohertz.

33. A method as set forth in claim 29, said tag antenna comprising a coil wound around a ferrite core, said ULF tag further comprising a warning device operable to identify said ULF tag upon emission of said identification signal.

34. A method as set forth in claim 29, each said ULF tag comprising a sensor operable to generate status data upon sensing a condition, said data processor being operable to process the status data received from said sensor and to emit data comprising said status data together with said identification data for receipt thereof by said field antenna.

35. A method as set forth in claim 34, said condition being selected from temperature, expiration of a freshness period, shock, dampness and radiation exposure.

36. A system for communicating with hearing-impaired people, said system comprising:
i) a hearing aid device carried at an ear of each of the people, said hearing aid device comprising:
a) a tag antenna operable at a low radio frequency below 1 megahertz, said tag antenna comprising a coil wound around a ferrite core;
b) a communication device operatively connected to said tag antenna and operable to receive data therefrom at said low radio frequency,
d) an energy storage device operable to activate said communication
ii) a field antenna disposed at an orientation and within a distance from each of the people that permits effective communication with the hearing aid device thereof at said low radio frequency,
iii) a field transmitter in operative communication with said field antenna, said field reader being operable to send data to said hearing aid device.

37. A system as set forth in claim 36, said field antenna being a loop antenna.
